(19) United States
(12) Patent Application Publication
(10) Pub. No.: US 2013/0164004 A1
(43) Pub. Date: Jun. 27, 2013

(54) IMAGE FORMING APPARATUS

(71) Applicant: CANON KABUSHIKI KAISHA, Tokyo (JP)

(72) Inventor: Ryuta Ai, Tokyo (JP)

(73) Assignee: CANON KABUSHIKI KAISHA, Tokyo (JP)

(21) Appl. No.: 13/773,964

(22) Filed: Feb. 22, 2013

Related U.S. Application Data
(63) Continuation of application No. PCT/JP2011/069975, filed on Aug. 26, 2011.

(30) Foreign Application Priority Data
Aug. 27, 2010 (JP) 2010-191252

(51) Int. Cl. G03G 15/01

(52) U.S. Cl. CPC G03G 15/0178
USPC 399/40

(57) ABSTRACT

An image forming apparatus including: color image forming means for effecting image formation with a color toner on the basis of color image data; transparent image forming means for effecting image formation, on the basis of transparent image data, with a transparent toner on a color toner image formed by the color toner forming means; fixing means for fixing a formed image, on a recording material, of the transparent toner superposed on the color toner; and control means for controlling the color image forming means, so that a toner amount per unit area of the color toner at a superposing portion of the transparent toner on the color toner image is less than that of the color image data at the superposing portion.

### TECHNICAL FIELD

The present invention relates to an image forming apparatus, such as a copying machine, a printer or a facsimile machine, for effecting image formation by using a color toner and a transparent toner (clear toner).

### BACKGROUND ART

In recent years, in the image forming apparatus of an electrophotographic type, a quality of an image which is a product of the image forming apparatus is increased to a level such that it is close to a print by image quality improvement and definition improvement of the image forming apparatus. Further, as a new value added, the image forming apparatus which treats toners of a particular color such as red or blue in addition to conventional toners of CMYBk (cyan, magenta, yellow, black) has also been commercialized. Further, in recent years, the image forming apparatus in which a toner, of a special color of colorless, such as a transparent toner for glossiness adjustment is treated for providing gloss to the print has also been used.

A user effectively uses these toners and can generate an output product with a high value added. For example, there is printing such as whole surface coating for superposedly printing (forming) the transparent toner on a whole surface of a color print or partial coating for superposedly printing partly on the color print. The whole surface coating using the transparent toner can provide print surface protection or feeding of gloss to the recording material by printing the transparent toner on the entire surface of the recording material after color printing is effected. Further, the partial coating using the transparent toner can be widely used for partial gloss, partial ornament by partly effecting the transparent toner printing on the recording material after the color printing is effected.

Incidentally, with the image quality improvement, a degree of demand for color stability of the product is being increased and for this purpose, there is a need to keep a density gradation property of the toner at a constant level. For example, a technique in which a density gradation correcting patch (test image) is formed on a photosensitive drum or an intermediary transfer belt, and the patch is detected by a sensor or the like and is fed back to the image forming apparatus to correct the gradation property has been known.

In recent years, a technique in which image density correction is made in a state closer to the product, i.e., the patch is formed on the recording material such as paper, not on the photosensitive drum or the intermediary transfer belt, to effect toner density gradation correction has been known. That is, in a state in which a gradation correcting image (patch) is fixed on the recording material, the density of the patch is detected by a density detecting sensor and a detection result is fed back thereby to effect the toner density gradation correction.

Such toner density gradation correction is effected with respect to image formation of the color toner. On the other hand, also with respect to the transparent toner, if the gradation correcting image is formed on the recording material and the density is detected to effect transparent toner density gradation correction similarly as in the color toner, a gloss characteristic by the transparent toner can be easily produced faithfully. However, when the transparent toner is formed on the recording material, the toner is transparent and therefore cannot be read by the density detecting sensor. Therefore, a technique in which the color toner and the transparent toner are mixed to form a patch has been known (Japanese Laid-Open Patent Application (Tokkai) 2010-113007).

### DISCLOSURE OF INVENTION

Incidentally, in the case where the transparent toner image is partly formed on the image formed with the color toner, there is such a characteristic that the density of the color toner coated with the transparent toner is seen so as to become high compared with the case where the transparent toner is not formed. This is because in the case where the transparent toner is formed on the color toner, light is absorbed by a transparent toner layer to decrease a diffused reflection component and thus the toner is recognized by eyes in a deep state.

Accordingly, in the case where the glossiness is partly improved by the partial coating using the transparent toner, the glossiness is improved by the transparent toner but at a color toner portion covered with the transparent toner, the density becomes high only at the portion. As a result of this, density non-uniformity is generated between the portion partly covered with the transparent toner and another portion.

The present invention aims at, in view of such circumstances, realizing a structure capable of suppressing the density non-uniformity even in the case where the image by the color toner is partly covered with the transparent toner.

According to an embodiment of the present invention, there is provided an image forming apparatus comprising: color image forming means for effecting image formation with a color toner on the basis of color image data; transparent image forming means for effecting image formation, on the basis of transparent image data, with a transparent toner on a color toner image formed by the color toner forming means; fixing means for fixing a formed image, on a recording material, of the transparent toner superposed on the color toner; and control means for controlling the color image forming means, so that a toner amount per unit area of the color toner at a superposing portion of the transparent toner on the color toner image is less than that of the color image data at the superposing portion.

### BRIEF DESCRIPTION OF THE DRAWINGS

FIG. 1 is a schematic illustration of an image forming apparatus according to First Embodiment of the present invention.

FIG. 2A is a schematic illustration showing, in an enlarged manner, an image forming portion for forming an image by a color toner, and FIG. 2B is a view showing a single station in an extraction manner.

FIG. 3 is, similarly, a schematic illustration showing, in an enlarged manner, an image forming portion for forming an image by a transparent toner.

FIG. 4 is a graph showing a gloss characteristic of the transparent toner.

Part (a) of FIG. 5 is a schematic illustration of a color sensor, and (b) of FIG. 5 is a schematic view of a light-receiving portion of the color sensor.

FIG. 6 includes schematic views, for illustrating a density change of the transparent toner formed on a cyan toner, showing (a) a state in which the transparent toner is not superposed on the cyan toner and (b) a state in which the transparent toner is superposed on the cyan toner, respectively.

FIG. 7 is a graph showing, with respect to a transparent toner amount per unit area, a gloss characteristic and a density change of a cyan toner density.

FIG. 8 is a schematic sectional vie of a test patch in which the transparent toner is formed on the color toner by changing the toner amount per unit area.

FIG. 9 is a block diagram of a control portion of the image forming apparatus in this embodiment.

FIG. 10 is a flow chart of a test patch forming process for forming the transparent toner on the color toner by changing the toner amount per unit area.

FIG. 11 is a schematic plan view showing the test patch for color toner gradation control.

FIG. 12 is a graph showing a relationship between a contrast potential and an image density.

FIG. 13 is a graph showing a relationship between a charging bias and a surface potential of a photosensitive drum.

FIG. 14 is a schematic plan view of the test patch in which the transparent toner is formed on the color toner by changing the toner amount per unit area.

FIG. 15 is a graph showing a relationship between the contrast potential and the image density of the test patch.

FIG. 16 is a flow chart showing a preparation process of LUT for correcting the toner amount per unit area of the color toner in the case where the transparent toner is superposed.

FIG. 17 is a schematic plan view of the test patch in the case where the transparent toner is not superposed on the color toner of each of Y, M, C and Bk.

FIG. 18 is a schematic plan view of the test patch in the case where the transparent toner is superposed on the color toner of each of Y, M, C and Bk.

FIG. 19 is a graph for illustrating the LUT for correcting the toner amount per unit area of the color toner in the case where the transparent toner is superposed.

FIG. 20 is a schematic illustration of an image forming apparatus according to Second Embodiment of the present invention.

### BEST MODE FOR CARRYING OUT INVENTION

### First Embodiment

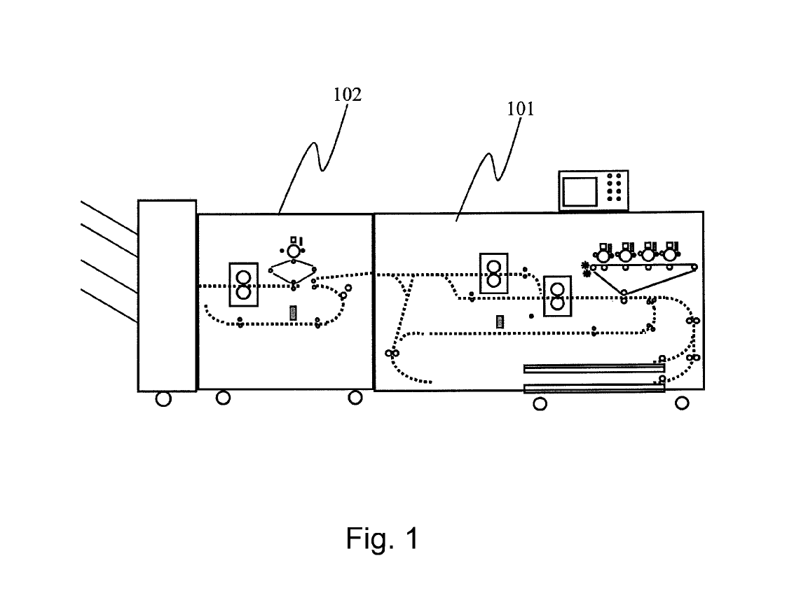

First Embodiment of the present invention will be described by using FIG. 1 to FIG. 19. Incidentally, with respect to a relative arrangement, numerical values and the like of constituent elements described in this embodiment, the scope of the present invention is not intended to be limited to only those unless otherwise particularly specified.

### [Image Forming Apparatus]

A schematic structure of an image forming apparatus of this embodiment will be described by using FIG. 1 to FIG. 3. FIG. 1 shows the schematic structure of the whole image forming apparatus in this embodiment. This image forming apparatus is an electrophotographic printer for effecting image formation by using an electrophotographic process. The image forming apparatus in this embodiment is one in which a color toner image forming portion 101 and a transparent toner image forming portion 102 which include respective color toners of Y (yellow), M (magenta), C (cyan) and Bk (black) are connected. Here, the color toner image forming portion 101 corresponds to a color image forming means for effecting image formation on the basis of color image data, and the transparent toner image forming portion 102 corresponds to a transparent image forming means for effecting image formation on the basis of a transparent image data, respectively. In the case of such an image forming apparatus in this embodiment, at the color toner image forming portion 101, the color toner image is transferred and fixed on a recording material and thereafter this recording material is conveyed to the transparent toner image forming portion 102. Then, the transparent toner image is superposedly transferred and fixed on the color toner image, so that a resultant product is outputted.

### [Color Toner Image Forming Portion]

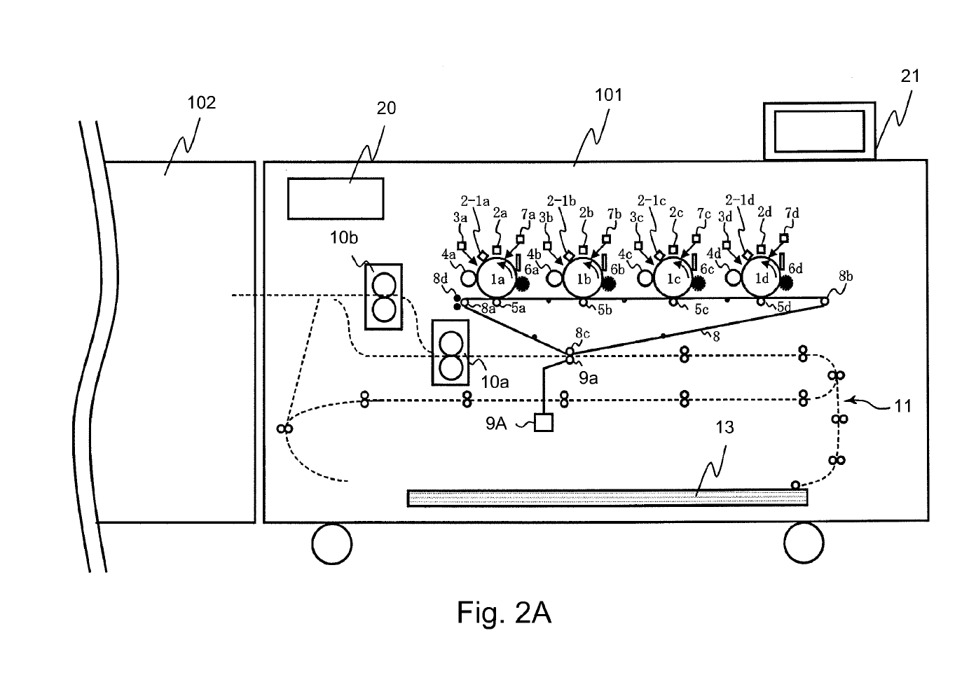

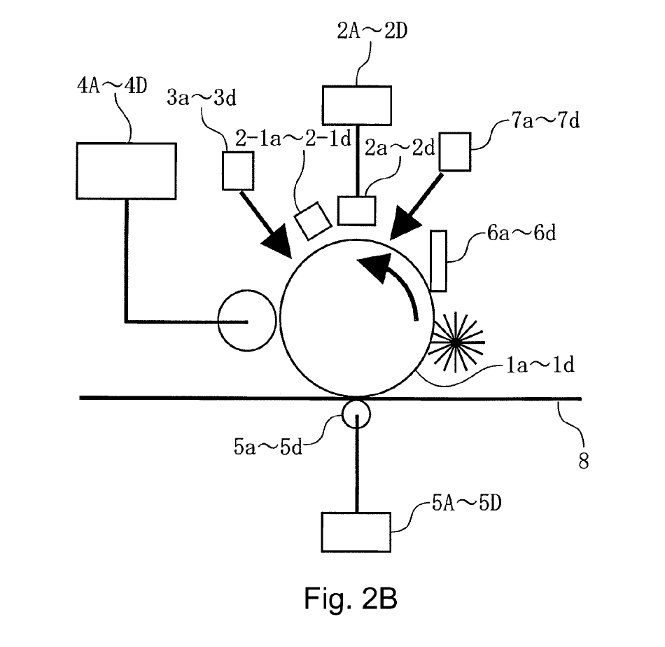

First, by FIG. 2A and FIG. 2B, the color toner image forming portion 102 will be described. The image forming portion 102 is of a tandem type including image forming stations for four colors of Y, M, C and Bk. Here, the order of arrangement of the respective colors is no object but in this embodiment, from the left in FIG. 2A< the order is Y, M, C and Bk. Further, suffixes a, b, c and d are added to symbols (reference numerals) of members constituting the stations for the colors, respectively, but the members are substantially the same except that the colors of the toners are different from each other. At peripheries of photosensitive drums 1a-1d which are an image bearing member (electrophotographic photosensitive member), corona chargers 2a-2c which are a charging means, developing devices 4a-4d which are a developing means, and cleaning devices 6a-6d are disposed. Further, at a position adjacent to the photosensitive drums 1a-1d, an intermediary transfer belt 8 which is another image bearing member (intermediary transfer member) is disposed, and at opposing positions to the respective photosensitive drums 1a-1d via the intermediary transfer belt 8, primary transfer rollers 5a-5d which are a transfer means are disposed.

As shown in FIG. 2B, to the corona chargers 2a-2d, power sources 2A-2D each for applying a charging bias are connected, respectively. Further, to the developing devices 4a-4d, power sources 4A-4D each for applying a developing bias are connected, respectively. Further, to the primary transfer rollers 5a-5d, power sources 5A-5D each for applying a primary transfer bias are connected, respectively. These power sources are controlled by an image control portion (image controller) 20 which is a control means. Further, a light quantity and an exposure time (pulse width modulation, PWM control) by the exposure devices 3a-3d are also controlled by the image controller 20.

Further, the intermediary transfer belt 8 is stretched by a plurality of rollers 8a-8c, and at an opposing position to the stretching roller 8c via the intermediary transfer belt 8, a secondary transfer roller 9a which is a transfer means is disposed. To the secondary transfer roller, a power source 9A for applying a secondary transfer bias is connected. Also this power source 9A is controlled by the image controller 20.

Hereinbelow, description will be made along steps of image formation. By the image controller 20, control of the image formation is effected, so that the photosensitive drums 1a-1d which is the image bearing member (electrophotographic photosensitive member) are rotated in an arrow direction, and by applying the charging bias by the corona chargers 2a-2d, the surfaces of the photosensitive drums 1a-1d are electrically charged to a certain potential. In place of the corona charger, a charger of a contact type such as a charging roller may also be used.

Next, by the exposure devices 3a-3d, the surfaces of the photosensitive drums 1a-1dc are irradiated with exposure light depending on image information (color image data), so that electrostatic latent images are formed on the surfaces of the photosensitive drums 1a-1d. The electrostatic latent images formed on the surfaces of the photosensitive drums 1a-1d are developed as toner images (developer images) by applying a developing bias to the developing devices 4a-4d to deposit the toners (developers). Then, by applying a transfer bias to the primary transfer rollers 5a-5d, the toner images formed on the surfaces of the photosensitive drums 1a-1d, respectively, are successively transferred onto the intermediary transfer belt 8, so that the respective color toner images are superposed on the intermediary transfer belt 8 to obtain a full-color toner image.

The full-color toner image on the intermediary transfer belt 8 is transferred onto the recording material by applying a secondary transfer bias to the secondary transfer roller 9a. The recording material is timed to the full-color toner image and is conveyed from a cassette 13, which is a sheet feeding means, by a connecting means 11 constituted by a conveying path and a plurality of conveying rollers. Incidentally, in the image forming apparatus in this embodiment, the cassette 13 for stacking (sheets of) the recording material is provided in a plurality of portions, and recording material sizes of a plurality of types of, e.g., B4, A3, A4, B5 and the like are selectable.

The full-color toner image transferred on the recording material is conveyed to fixing devices 10a and 10b which are a fixing means and is heat-fixed on the recording material. Incidentally, in the case of this embodiment, two fixing devices 10a and 10b are disposed. This is because in the case where the image is fixed on the recording material, such as thick paper, which is not readily heated, by passing the recording material through the two fixing devices 10a and 10b, heat fixing is reliably enabled without lowering a speed of the image formation. On the other hand, in the case where the image is fixed on the recording material, such as plain paper, such that only a small heating amount is required, the recording material is passed through only the fixing device 10a.

Incidentally, the toners (transfer residual toner) remaining on the surfaces of the photosensitive drums 1a-1d without being transferred are removed and collected by the cleaning devices 6a-6d. The cleaning devices 6a-6d include cleaning blades and fur brushes which are contacted to the photosensitive drums 1a-1d, and collect the toners by scraping off the toners from the surfaces of the photosensitive drums 1a-1d by these members. Further, the toner remaining on the intermediary transfer belt 8 without being transferred is removed and collected by a belt cleaning device 8d. Further, as a charge-removing means for removing potentials remaining on the surfaces of the photosensitive drums 1a-1d, pre-charge exposure devices 7a-7d are provided.

Next, the respective constituent elements used in this embodiment will be described in further detail. Further, the photosensitive drums 1a-1c are an electrophotographic photosensitive member of a rotation drum type and have a photosensitive layer formed of an OPC (organic photoconductor) having a negatively charging characteristic. That is, the photosensitive drum is roughly constituted by forming, on an electroconductive support, the photosensitive layer (photosensitive film) including a photoconductive layer using the organic photoconductor as a main component. The OPC is constituted in general by laminating a charge-generating layer, a charge-transporting layer and a surface protective layer, which are formed of organic materials, on a metal support (supporting member for the photosensitive member) as the electroconductive support. Incidentally, in this embodiment, the photosensitive drum is formed of, e.g., about 84 mm in diameter, and is rotationally driven about a center shaft (not shown) in an arrow direction in FIG. 1 (counterclockwise) at a peripheral speed of 300 mm/s.

Further, the corona chargers 2a-2d is a non-contact charging member and include a charging wire (corona discharge electrode), a grid electrode and a shield case. To the charging wire, an external power source is connected via a charging wire bias application circuit. By applying a charging wire bias (high charging wire voltage) to the charging wire to generate corona discharge, the photosensitive drums 1a-1d are electrically charged. With respect to the electric charges which generate the corona discharge by the charging wire, a grid bias (grid voltage) applied to the grid electrode connected to a constant-voltage power source (grid bias application power source) is controlled. By this, an amount of the electric charges imparted to the photosensitive drums 1a-1d as a member to be charged is adjusted, so that charge potentials of the photosensitive drums 1a-1d are controlled. The grid bias application power source is controlled by the image controller 20 with respect to a condition of ON/OFF timing, output value and the like of the grid bias. Incidentally, in the case of this embodiment, the control of the charging bias is effected by controlling the gird bias. Accordingly, the above-described power sources 2A-2D correspond to the grid bias application power source. Further, the charge potentials on the photosensitive drums 1a-1d can be measured by drum surface potential sensors 2-1a to 2-1d.

Further, the exposure devices 3a-3d include a semiconductor laser for effecting, on the basis of image information, image exposure to light of the photosensitive drums 1a-1d uniformly charged at their surfaces by the corona chargers 2a-2d. Incidentally, in place of the semiconductor laser, another means such as an LED may also be used.

Further, the developing devices 4a-4d include a developing container in which a two-component developer which is a mixture of a non-magnetic toner and a magnetic carrier is accommodated and a developing sleeve provided rotatably at an opening of this developing container. The toner is configured to be triboelectrically charged to the negative polarity by friction with the magnetic carrier.

The toner is, e.g., one obtained by kneading a resin binder principally of polyester with a pigment and then by pulverizing and classifying the kneaded product to have an average particle size of about 6 μm. Further, as the carrier, e.g., in a surface oxidization region, unoxidized metals such as iron, nickel, cobalt, manganese, chromium and rare earth; their alloys; or oxide ferrite or the like are suitably usable, and a manufacturing method of these magnetic particles is not particularly limited.

Further, the carrier is 20-50 μm, preferably 30-40 μm in volume-average particle size and is 10⁷ Ω·cm or more, preferably 10⁸ Ω·cm or more in resistivity. In this embodiment, as the carrier, e.g., one including a core principally of ferrite coated with silicone resin is used and is 35 μm in volume-average particle size, 5×10⁹ Ω·cm in resistivity, and 200 emu/cc in magnetization. Such toner and carrier are mixed in a ratio of about 8:92 in terms of a weight ratio, and are used as the two-component developer of 8% in toner concentration (TD ratio).

Further, the developing sleeve has the function of magnetically holding the developer in the developing container by a magnet fixedly disposed in an inside thereof and of feeding the developer to a developing portion which is a gap portion with the photosensitive drums 1a-1d. Further, to the developing sleeve, the developing power source (4A-4D) for applying the developing bias in the form of superposition of a DC voltage (−600 V) and an AC voltage (1800 V in Vpp) is connected, and the toner is deposited on the electrostatic latent image by this developing bias to effect a developing process. This developing power source is controlled by a high-voltage control portion of the image controller 20. Further, at this time, a charge amount of the toner deposited on the photosensitive drums 1a-1d is, e.g., about −30 μC/g.

Further, to the primary transfer rollers 5a-5d, the transfer power sources (5A-5D) for applying the primary transfer bias of an opposite polarity to a normal charge polarity (negative polarity) of the toner are connected. Further, regions where the intermediary transfer belt 8 and the photosensitive drums 1a-1d are press-contacted by the transfer rollers 5a-5d are primary transfer portions. Also to the secondary transfer roller 9, a transfer power source (9A) for applying a secondary transfer bias of the opposite polarity to the normal charge polarity (negative polarity) is connected. By the primary transfer bias, the toner images formed on the photosensitive drums 1a-1d are primary-transferred onto the intermediary transfer belt 8, and by the secondary transfer bias, the toner images transferred on the intermediary transfer belt 8 are secondary-transferred onto the recording material.

Further, the pre-charging exposure devices 7a-7d are a light-irradiation means for eliminating a history of the electrostatic latent images remaining on the photosensitive drums 1a-1d. The pre-charging exposure devices includes, in order to erase the electrostatic latent images remaining on the photosensitive drums 1a-1d after the transfer process by the primary transfer rollers 5a-5d, a light-emitting portion for effecting light irradiation of the photosensitive drums 1a-1d. As this light-emitting portion, e.g., one obtained by processing, in an array shape, an LED chip for emitting light of 600 nm in center wavelength is used. Further, the pre-charging exposure devices are configured so that each of their operations is controlled by the image controller 20, and specifically are configured so that a charge-removing condition such as ON/OFF timing and light quantity of the light irradiation is controlled.

Further, the fixing devices 10a and 10b are constituted by a fixing roller as a toner image heating member and a pressing roller as a pressing member. The fixing roller is rotationally driven in a predetermined rotational direction at a predetermined speed by an unshown driving source. In this embodiment, e.g., the fixing roller includes a core metal, made of a cylindrical metal (e.g., made of aluminum), of 74 mm in outer diameter, 6 mm in thickness and 350 mm in length. On the core metal, as a heat-insulating elastic layer, a silicone rubber (e.g., of 15 degrees in JIS-A hardness) is coated in a thickness of 3 mm. On the heat-resistant elastic layer, as a heat-resistant parting layer, a fluorine-containing resin (e.g., a PTFA tube) is coated in a thickness of 100 μm.

Further, inside the core metal of the fixing roller, as a heat generating member, e.g., a halogen heater of 1500 W in normal rated power is disposed, and the fixing roller is heated from the inside so that a surface temperature of the fixing roller is a predetermined target temperature. The surface temperature of the fixing roller is detected by a thermistor disposed at a sheet-passing portion of the fixing roller. Further, on the basis of this detected temperature, the halogen heater is ON/OFF-controlled by the image controller 20, so that the surface temperature is temperature-controlled at the predetermined target temperature of, e.g., 200° C.

Next, the pressing roller is pressed against the fixing roller at predetermined pressure by an unshown pressing means to form a fixing nip with the fixing roller, and is rotated by the fixing roller.

A width of the fixing nip with respect to a circumferential direction is, e.g., about 10 mm.

The pressing roller includes a core metal, made of a cylindrical metal (e.g., made of stainless steel), of 54 mm in outer diameter, 3 mm in thickness and 350 mm in length. On the core metal, as a heat-resistant elastic layer, a silicone rubber (e.g., of 20 degrees in JIS-A hardness) is coated in a thickness of 3 mm. On the heat-resistant elastic layer, as a heat-resistant parting layer, a fluorine-containing resin (e.g., a PTFA (perfluoroalkoxy resin) tube) is coated in a thickness of 100 μm.

Further, inside the core metal of the pressing roller, as a heat generating member, e.g., a halogen heater of 400 W in normal rated power is disposed, and the pressing roller is heated from the inside so that a surface temperature of the pressing roller is a predetermined temperature. The surface temperature of the pressing roller is detected by a thermistor disposed at a sheet-passing portion of the pressing roller. Further, on the basis of this detected temperature, the halogen heater is ON/OFF-controlled by the image controller 20, so that the surface temperature is temperature-controlled at the predetermined target temperature of, e.g., 150° C.

### [Transparent Toner Image Forming Portion]

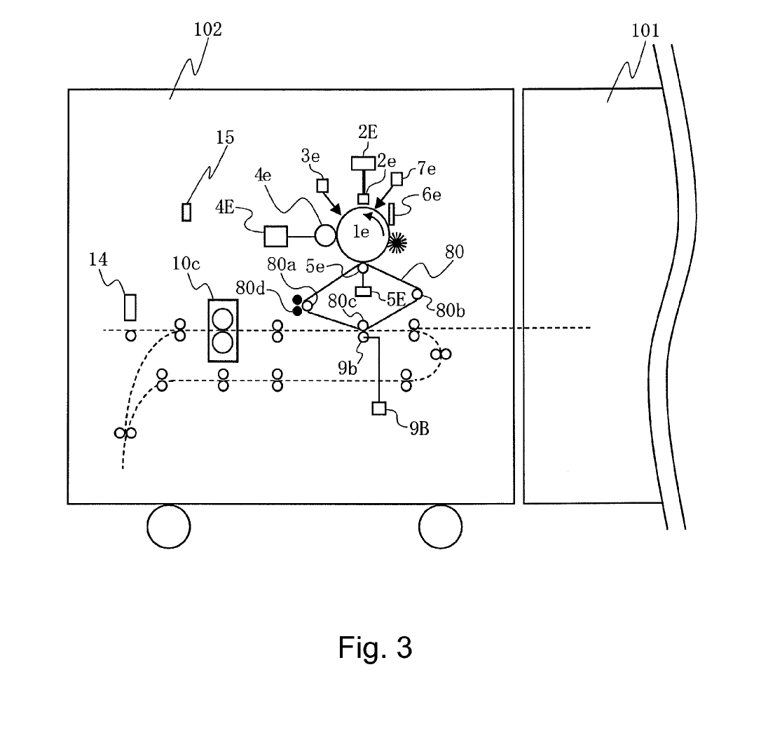

Next, by FIG. 3, the transparent toner image forming portion 102 will be described. When the image formation is started at the image forming portion 101, a signal indicating that the image formation is started is sent from the image controller 20 of the color toner image forming portion 101 to the transparent toner image forming portion 102. Then, at the transparent toner image forming portion 102, the image formation is started on the basis of transparent image data. At a periphery of a photosensitive drum 1e which is an image bearing member (electrophotographic photosensitive member), a corona charger 2e which is a charging means, a developing device 4e which is a developing means, and a cleaning device 6e are disposed. Further, at a position adjacent to the photosensitive drum 1e, an intermediary transfer belt 80 which is another image bearing member (intermediary transfer member) is disposed, and at opposing a position to the photosensitive drum 1e via the intermediary transfer belt 80, primary transfer roller 5e which is a transfer means are disposed.

To the corona charger 2e, a power source 2E for applying a charging bias is connected. Further, to the developing device 4e, a power source 4E each for applying a developing bias is connected. Further, to the primary transfer roller 5e, a power source 5E each for applying a primary transfer bias is connected, respectively. These power sources are controlled by an image control portion (image controller) 20 which is a control means. Further, a light quantity and an exposure time (pulse width modulation, PWM control) by the exposure device 3e is also controlled by the image controller 20.

Further, the intermediary transfer belt 80 is stretched by a plurality of rollers 80a-80c and the primary transfer roller 5e, and at an opposing position to the stretching roller 80c via the intermediary transfer belt 80, a secondary transfer roller 90a which is a transfer means is disposed. To the secondary transfer roller, a power source 90A for applying a secondary transfer bias is connected. Also this power source 90A is controlled by the image controller 20.

Further, the toners (transfer residual toner) remaining on the surfaces of the photosensitive drums 1a-1d without being transferred are removed and collected by the cleaning device 6e. Further, the toner remaining on the intermediary transfer belt 80 without being transferred is removed and collected by a belt cleaning device 80d. Further, as a charge-removing means for removing a potential remaining on the surface of the photosensitive drum 1e, a pre-charge exposure device 7e is provided. Further, the toner images transferred onto the recording material are conveyed to a fixing device 10c which is the fixing means, and is heat-fixed on the recording material.

Incidentally, specific constitutions and actions of these respective constituent members are similar to those for the above-described color toner image forming portion 101.

### [Color Toner and Transparent Toner]

The color toner and the transparent toner in this embodiment are prepared by a pulverization method. As a binder resin in the case where the toner particles are manufactured by the pulverization method, homopolymers, of styrene and its substitution product, such as polystyrene and polyvinyltoluene are cited. Further, styrene-propylene copolymer, styrene-vinyltoluene copolymer, styrene-vinylnaphthalene copolymer, styrene-methyl acrylate copolymer, styrene-ethyl acrylate copolymer, and styrene-butyl acrylate copolymer are cited. Further, styrene-octyl acrylate copolymer, styrene-dimethylaminoethyl acrylate copolymer, styrene-methyl methacrylate copolymer, and styrene-ethyl methacrylate copolymer are cited. Further, styrene-dimethylaminoethyl methacrylate copolymer, styrene-vinylmethyl ether copolymer, styrene-vinylethyl ether copolymer, styrene-vinylmethyl ketone copolymer, and styrene-butadiene copolymer are cited. Further, styrene-based copolymers such as styrene-isoprene copolymer, styrene-maleic acid copolymer and styrene-maleate copolymer are cited. Further, polymethyl methacrylate, polybutyl methacrylate, polyvinyl acetate, polyethylene, polypropylene, polyvinyl butyral, silicone resin, polyester resin, polyamide resin, epoxy resin, polyacrylic resin, and the like can be used singly or in mixture. Particularly, the styrene-based copolymers and the polyester resin are preferred in terms of a developing characteristic, a fixing property and the like.

A glass transition temperature (Tg) of the binder resin may preferably be 40-70° C., more preferably be in a range of 45-65° C. These are used singly or generally by appropriately mixing monomers so that a theoretical glass transition temperature (Tg) described in publication: Polymer Handbook, Second Edition III—pages 139-192 (John Wiley & Sons Inc.) shows 40-70° C.

The color toner contains a colorant for imparting coloring power. As an organic pigment or dye to be preferably used, the following ones are cited. Incidentally, the transparent toner does not contain the colorant but in an unfixed state, is seen whitish in some cases but becomes substantially colorless and transparent after the fixing.

As an organic pigment or an organic dye as a cyan system colorant, a copper phthalocyanine compound and its derivative, an anthraquinone compound, a basic dye lake compound, and the like can be utilized.

As the organic pigment or the organic dye as a magenta system colorant, a condensed azo compound, a diketopyroropyrrole compound, anthraquinone and a quinacridone compound are used. Further, a basic dye lake compound, a naphthol compound, a benzoimidazolone compound, a thioindigo compound and a perylene compound are used.

As the organic pigment or the organic dye as a yellow system colorant, a condensed azo compound, an isoindorinone compound, an anthraquinone compound, an azo metal complex, a mechine compound and an arylamide compound are used.

As the colorant for the black toner, carbon black and the like are cited.

These colorants can be used singly or in mixture or in a solid solution state. The colorants used for the color toners are used from viewpoints of hue angle, chroma, lightness, light resistance, OHP transparency, and dispersibility into the toner. An addition amount of the colorant used is 1-20 wt. parts per 100 wt. parts of the binder resin.

Into the toner, a charge control agent may be mixed in order to stabilize a charging characteristic. As the charge control agent, a known one can be used and particularly the charge control agent which has a fast charging speed and which is capable of stably maintaining a certain charging amount is preferable.

In the case where the toner particles are manufactured by the pulverization method, a known method is used but, e.g., the toner particles can be obtained in the following manner. Components necessary for the color toner particles such as the binder resin, the parting agent, the charge control agent and the colorant, and other additives and the like are sufficiently mixed by a mixing device such as Henschel mixer or a ball mill. Then, the mixture is melted and kneaded by a heat-kneading machine such as a heating roller, a kneader or an extruder, so that the resins and the like are mutually melted and then are subjected to solidification by cooling and pulverization, and thereafter are classified and as desired are subjected to surface treatment, and thus the toner particles can be obtained. The order of the classification and the surface treatment may be one wherein which step is performed early. In the classification step, it is preferable that a multi-division classifying machine is used in terms of manufacturing efficiency.

The pulverization step can be performed by a method using a known pulverizing device of a mechanical impact type, a jet type or the like. In order to obtain the color toner having a specific degree of circularity, it is preferable that the pulverized color toner particles are further pulverized under heating or are auxiliary subjected to a process in which mechanical impact is applied to the color toner particles. Further, a hot water bath method in which the color toner particles which are finely pulverized (and classified as desired) are dispersed in hot water, a method in which such color toner particles are passed through thermal air current, and the like method may also be used.

Further, it is preferable that the toner contains (externally added) inorganic fine particles and a primary average particle size of the inorganic fine particles is 4-80 nm. The inorganic fine particles subjected to hydrophobizing treatment are more preferred from a viewpoint of maintaining the charge amount of the toner particles even under a high-humidity environment to prevent toner scattering. As the inorganic fine particles, fine particles of silica, alumina, titania and the like can be used.

The yellow toner, the cyan toner, the magenta toner, the black toner, and the transparent toner which are used in the image forming apparatus in this embodiment are as follows.

Cyan toner: This toner was prepared by adding 5 wt. parts of a phthalocyanine pigment, 4 wt. parts of a charge control agent and an external additive into 100 wt. parts of a polyester-based main binder of about 5000 in number-average molecular weight.

Magenta toner: This toner was prepared by adding 4 wt. parts of C.I. Solvent Red 49, 0.7 wt. part of Dye C.I. Pigment Red 122, 4 wt. parts of a charge control agent and an external additive into 100 wt. parts of a polyester-based main binder of about 5000 in number-average molecular weight.

Yellow toner: This toner was prepared by adding 5 wt. parts of C.I. Pigment Yellow 17, 4 wt. parts of a charge control agent and an external additive into 100 wt. parts of a polyester-based main binder of about 5000 in number-average molecular weight.

Black toner: This toner was prepared by adding 5 wt. parts of carbon black, 4 wt. parts of a charge control agent and an external additive into 100 wt. parts of a polyester-based main binder of about 5000 in number-average molecular weight.

Transparent toner: This toner was prepared by adding 4 wt. parts of a charge control agent and an external additive into 100 wt. parts of a polyester-based main binder of about 5000 in number-average molecular weight.

Each of the above-described toners of 5 types was mixed with magnetic carrier particles to obtain a two-component developer.

### [Image Forming Mode of Transparent Toner]

In the image forming apparatus in this embodiment an image forming mode by the transparent toner includes a whole surface image forming mode and a partial image forming mode.

In the whole surface image forming mode, the transparent toner image is formed by superposing the transparent toner image on the four color toner images. By forming the transparent toner on the color toners in the whole region, glossiness on the recording material can be uniformly controlled. That is, the whole surface image forming mode is not a mode in which glossiness of the transparent image itself is increased and decreased as in the partial image forming mode described later, but is a mode in which glossiness in a substantially whole region where the image formation on the recording material is enabled is intended to be improved.

In the partial image forming mode, a clear mark, i.e., a character portion, a symbol portion or a pattern portion is formed with the transparent toner by superposing the transparent toner image on a part of the color toner image of a single color or of the color toner images of a plurality of colors. The transparent image data is data for forming such a clear mark. That is, the partial image forming mode is, as described later, a mode in which glossiness of the clear mark itself is increased or decreased.

### [Gloss Characteristic of Transparent Toner]

A means for changing the gloss (glossiness) of the transparent toner image by using the transparent toner will be described. First, when the reason why the gloss of the toner image is changed is described, if a portion where the toner image is formed is a completely smooth surface and there is no diffused reflection, the gloss at the portion where the toner image is formed is changed by reflectance and thickness of the toner material. That is, it would be considered that the gloss of the toner image is monotonically increased or monotonically decreased from glossiness determined by the reflectance of the recording material toward glossiness determined by the reflectance of the toner material in the case where the toner image is sufficiently thick.

By changing the toner amount per unit area of the transparent toner on the recording material, the glossiness at the image portion by the transparent toner can be changed. This charge in glossiness varies depending on the type of the recording material. The reason thereof is that the glossiness when the toner amount per unit area is small is changed from a high value if the glossiness at the recording material surface constituting the groundwork is high and that the glossiness when the toner amount per unit area is small is changed from a low value if the glossiness at the recording material surface constituting the groundwork is low. Accordingly, by changing a forming condition of the transparent toner image, it is possible to variously change the gloss (glossiness) of the transparent toner image to be formed.

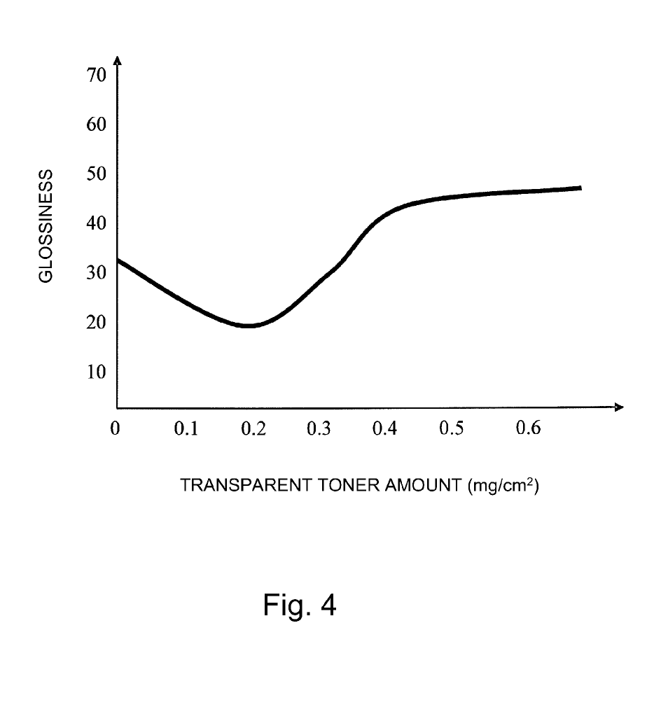

FIG. 4 is a graph showing a relationship between the toner amount per unit area (mg/cm²) of the transparent toner on the recording material in an unfixed state and the glossiness at that time. The glossiness in the unfixed state was measured by stopping the image forming apparatus before the toner is melted by the fixing device 10c and then by measuring the weight of the toner per unit area by a suction method. As the recording material, cast-coated paper which is highly-glossy paper (NS701, mfd. by Canon K.K., basis weight=150 g/m²) was used. The ordinate is the glossiness by a 60-degree gloss meter with a gloss checker (IG331, mfd. by Horiba, Ltd.), and the abscissa is the density of the transparent toner on the paper.

When the graph is viewed, it is understood that the glossiness becomes a minimum value of about 20 at the toner amount per unit area of 0.2 mg/cm². In the neighborhood of the toner amount per unit area of 0, the glossiness of the cast-coated paper is dominant and is gradually influenced by the toner amount per unit area. Then, it is understood that from the neighborhood of the transparent toner amount per unit area exceeding 0.4 mg/cm², the glossiness of the toner tends to be saturated at a large value.

### [Toner Density Sensor]

In this embodiment, the toner density is determined by detecting the toner, after being transferred and fixed, by a color sensor 14 which is a density detecting means. The color sensor 14 is, as shown in FIG. 3, disposed downstream of the fixing device 10e in a recording material conveying path so as to be directed toward the image forming surface of the recording material. Part (a) of FIG. 5 is a view for illustrating a structure of an example of the color sensor 14. This color sensor 14 includes a white LED 301 and a charge storage type sensor 302 provided with an RGB on-chip filter. The white LED causes white light to be obliquely incident on the recording material S, on which a patch 304 after the fixing, at an angle of 60 degrees, and detects diffused reflection light intensity in 0-degree direction by the charge storage type sensor 302. A light-receiving portion 303 of the charge storage type sensor 302 provided with the RGB on-chip filter includes a pixel in which R, G and B are independent of each other as shown in (b) of FIG. 5.

The charge storage type sensor used at the light-receiving portion 303 may also be constituted by a photodiode. Further, as another constitution, a constitution in which the incident angle of 0 degrees and the reflection angle of 60 degrees may also be employed. Further, the charge storage type sensor may also be constituted by an LED, from which light beams of three colors of RGB are emitted, and a sensor with no filter.

Such a color sensor 14 obtains an RGB value from the patch 30, after the fixing, formed on the recording material S. In order to convert the obtained RGB value into an optical density, a mathematical expression (1) shown below is used. In order to make the value equal to a value of a commercially available densitometer, correction coefficients km, kc, ky and kk are adjusted. Incidentally, an LUT is separately prepared and brightness information on RGB may also be converted into density information on MCMBk.

M=−km×log 10(G/255)

C=−kc×log 10(R/255)

Y=−ky×log 10(B/255)

Bk=−kk×log 10(G/255) (1)

On the basis of this chromacity information, control depending on the density or chromacity of the patch 304, after the fixing, formed on the recording material S is effected. Thus, before the image after the fixing is discharged to a sheet discharge portion, it becomes possible to automatically detect the density and chromacity of the patch image transferred and fixed on the recording material S.

[Density Characteristic in Case where Transparent Toner Image is Superposedly Formed on Color Toner Images]

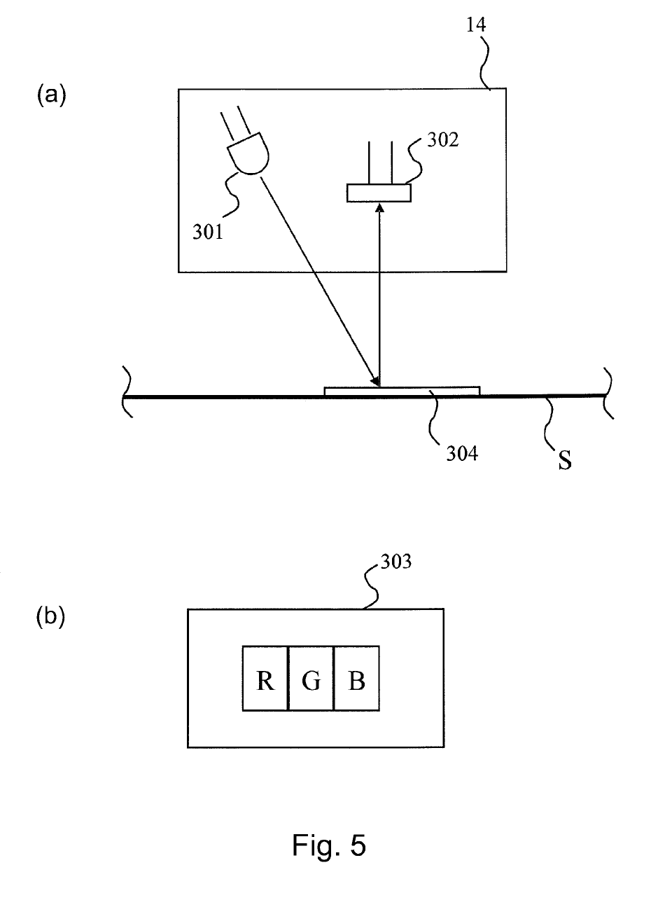

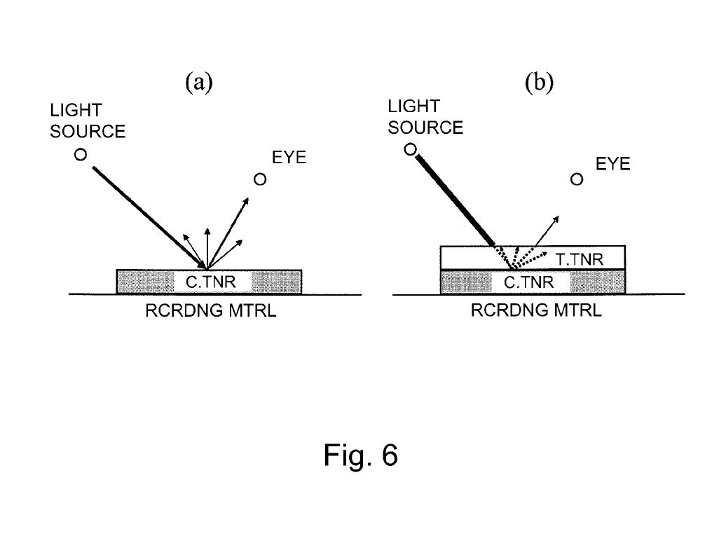

In the case where the transparent toner image is superposedly formed on the color toner images, there is a characteristic such that the density of the color toners covered (coated) with the transparent toner is seen so as to be high compared with the case where the transparent toner is not formed. The reason of this will be described by using FIG. 6. The color and its density can be detected in a manner that the light from a light source strikes the toner and causes absorption and diffused reflection and then a diffused reflection (light) component reaches eyes.

With a higher toner density, the light is move absorbed by the toner layer and thus the diffused reflection component is decreased, so that the toner becomes thick and is recognized by eyes ((a) of FIG. 6).

In the case where the transparent toner is formed on the color toners, before the light from the light source causes the diffused reflection on the color toners, the light is absorbed by the transparent toner layer, so that a diffused reflection effect is weakened and thus an amount of the light entering eyes is also decreased. As a result, the density of the color toners provided with the transparent toner is seen so as to be high ((b) of FIG. 6).

### [Density Adjustment of Transparent Toner]

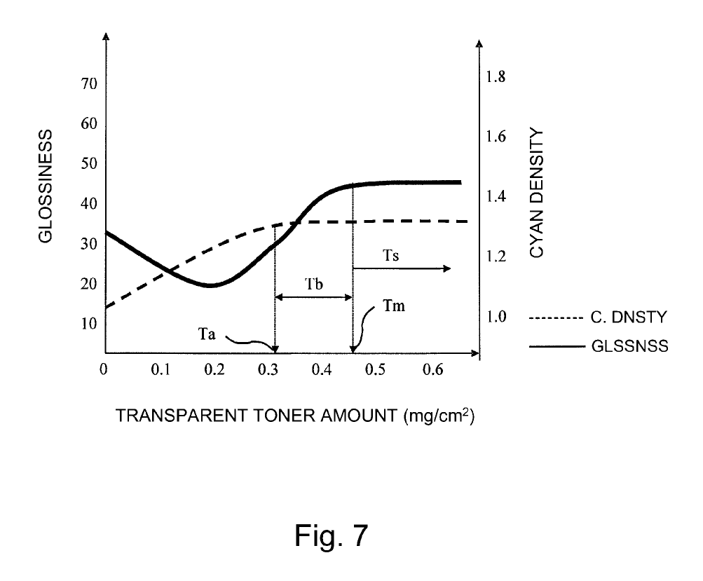

As described above, in the case where the transparent toner is formed on the color toners, the density at the color toner portion where the transparent toner is formed becomes high compared with the case where the transparent toner is not formed. FIG. 7 shows a relationship of the glossiness (solid line) and density (broken line) on the color toners with respect to the toner amount per unit area (mg/cm²) on the recording material before the fixing of the transparent toner. The toner amount per unit area of the transparent toner was controlled by changing a dither matrix print ratio, i.e., a duty ratio (exposure time) of PWM (Pulse Width Modulation) control of the exposure device 3e. Further, as the color toner, the cyan toner was used. The density of the cyan toner after the fixing was adjusted so as to be 1.0. The measured density was corrected by using the mathematical expression (1) so as to coincide with a density value by X-RITE 500 manufactured by X-RITE Co.

As is apparent from FIG. 7, with an increasing toner amount per unit area of the transparent toner, the density of the cyan toner is increased. Then, the increase in cyan (toner) density is saturated in the neighborhood of the transparent toner amount per unit area of 0.3 mg/cm² so that the density is stabilized in the neighborhood of 1.3. This is because when the transparent toner amount per unit area is 0.3 mg/cm² or more, a light attenuation effected by the transparent toner layer is saturated with respect to a visual recognition level by eyes.

On the other hand, also the glossiness of the transparent toner on the cyan toner is increased with the increase in transparent toner amount per unit area but tends to be saturated at the transparent of 0.45 mg/cm². This is because when the transparent toner amount per unit area is 0.45 mg/cm² or more, a surface shape of the transparent toner layer is stabilized and thus a total reflection characteristic is saturate at a constant level.

Therefore, when the transparent toner amount per unit area is obtained, if the density-saturated region is Tb and Ts, irrespective of the toner amount per unit area, the density characteristic is constant. Further, in order to minimize an amount of use of the transparent toner while keeping the density characteristic at the constant level, control in which the toner amount per unit area is made equal to Ta shown in the graph may only be required to be effected. That is, Ta is a density-saturated toner amount per unit area which is the transparent toner amount per unit area in which the increase in density is saturated with respect to the increase in transparent toner amount per unit area. In the above-described explanation, Ta is 0.3 mg/cm².

Further, if both of the density and the glossiness are in the region Ts where these are saturated, irrespective of the toner amount per unit area, both of the gloss characteristic and the density characteristic are constant. For this reason, in the case where both of the gloss characteristic and the density characteristic are made constant, control in which the toner amount per unit area is added to Tm shown in the graph may only be required to be effected. That is, Tm is a glossiness-saturated toner amount per unit area which is the transparent toner amount per unit area in which the glossiness of the transparent toner is saturated. In the above-described explanation, Tm is 0.45 mg/cm².

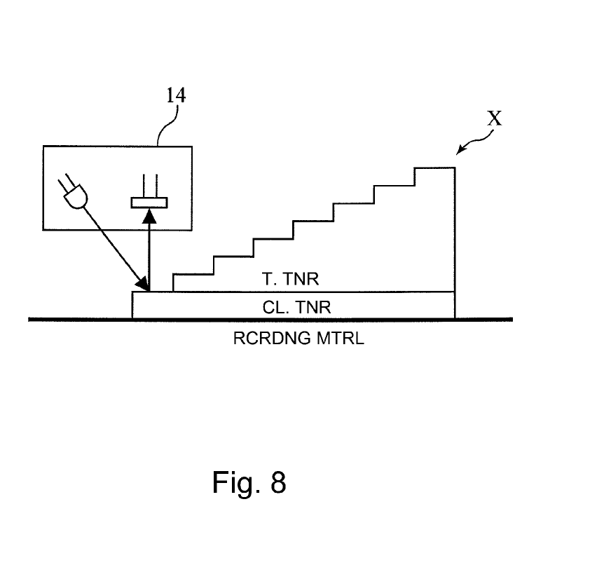

In this embodiment, Ta is obtained in the following manner. First, the color toner image is formed in a certain toner amount per unit area at the color toner image forming portion 101. Next, at the transparent toner image forming portion 102, a plurality of transparent toner images different in toner amount per unit area are formed on this color toner image as shown in FIG. 8, so that a first test image (test patch X) is formed. In the test patch X of FIG. 8, the toner amount per unit area of the transparent toner is increased stepwise from 0. Next, the density of the first test patch X fixed on the recording material by the fixing device 10c is detected by the color sensor 14. That is, the density at each of portions where the toner amount per unit area of the transparent toner is changed stepwise is detected by the color sensor 14.

Further, from the density of the first test patch X detected by the color sensor 14, a relationship (corresponding to the broken line of FIG. 7) between the transparent toner amount per unit area and the color toner density is derived. Then, from this relationship, Ta which is the density-saturated toner amount per unit area which is the transparent toner amount per unit area in which the increase in density is saturated with respect to the increase in toner amount per unit area of the transparent toner is calculated. Incidentally, in the case where Tm is obtained, there is a need to add Tb to Ta, but this point will be described later.

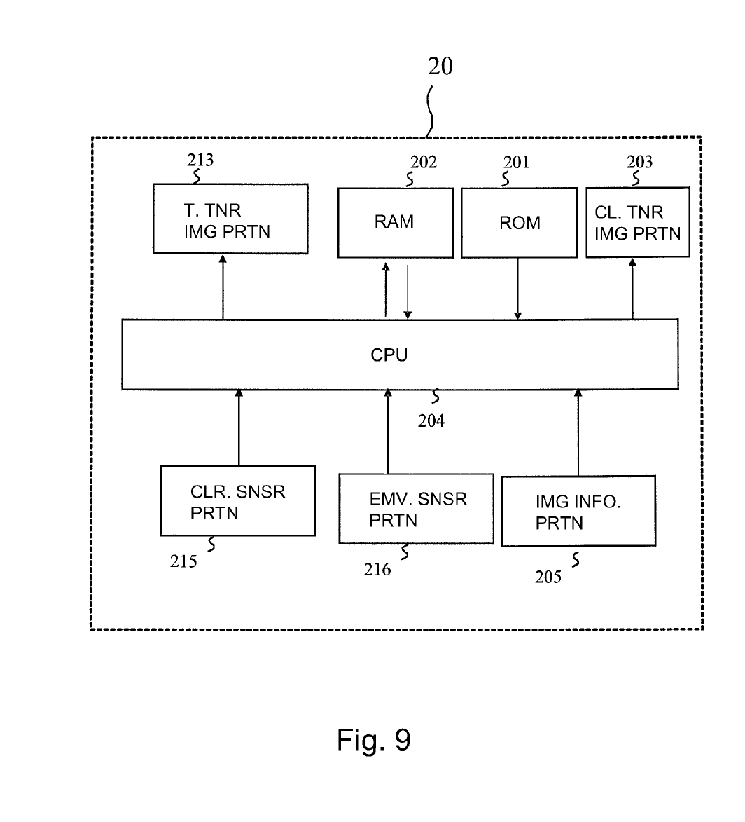

Detailed description of the above-described control, i.e., detailed description for setting the toner amount per unit area of the transparent toner will be made. FIG. 9 is a block diagram showing a constitution of the image controller 20 in this embodiment. The image controller 20 includes a CPU 204, a color toner image portion 203, a transparent toner image portion 213, ROM 201, RAM 202, an image information portion 205, a color sensor portion 215 and an environment sensor 216.

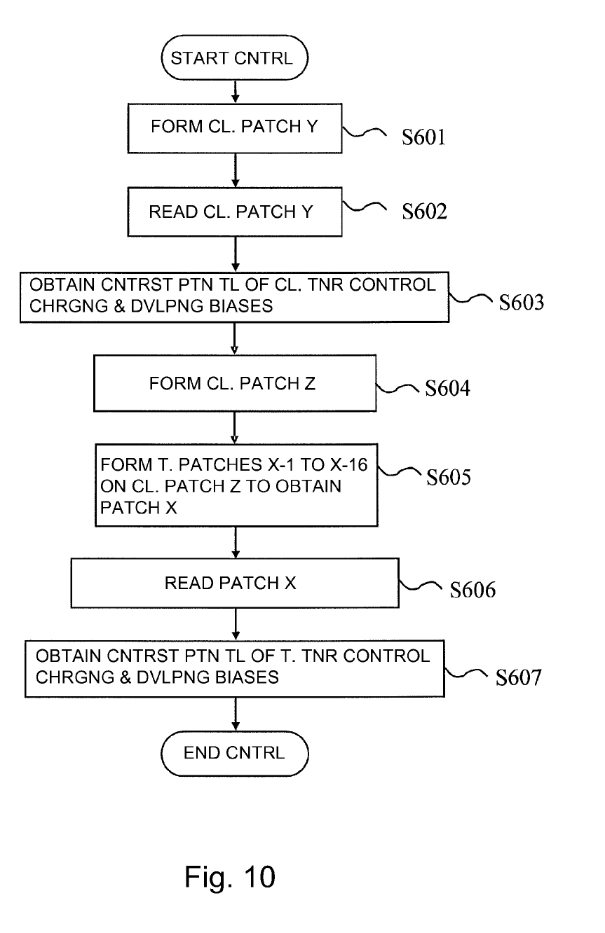

Further, in order to explain the details, the description will be made by using a flow chart shown in FIG. 10. The CPU 204 starts a transparent toner amount per unit area adjusting mode. This mode is started by satisfying any of conditions including main switch actuation from an image forming apparatus main assembly, a lapse of a predetermined time from the main switch actuation, a predetermined number of image formation sheets, and push, by an operator of a button, of e.g., “automatic gradation correction”, provided at an operating portion 21 (FIG. 2A, FIG. 2B).

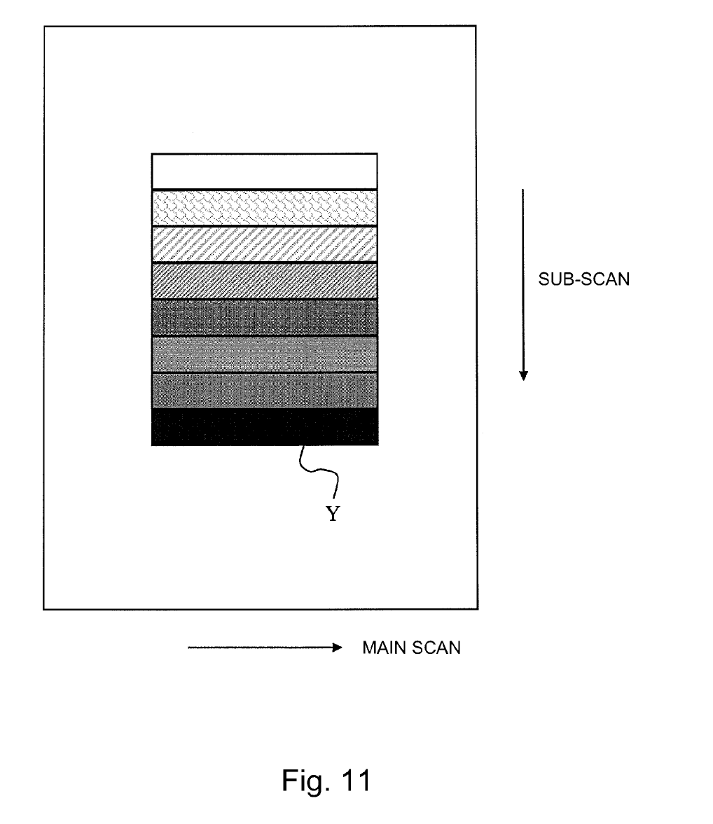

First, the CPU 204 writes, from the ROM 201, color toner image formation information for controlling the color toner amount per unit area and various bias settings during image formation into the RAM 201 for reading. Thereafter, the CPU 204 controls the color toner image portion 203, so that a color toner patch Y as shown in FIG. 11 is formed (S601). The patch Y is one obtained by forming a plurality of color toner images different in toner amount per unit area. In other words, the patch Y is formed so as to include a plurality of gradation levels. As a contrast potential when such a color toner patch Y is formed, an initial value which is registered in advance is used.

Further, the image forming apparatus in this embodiment includes a plurality of recording material cassettes and is capable of selecting recording material sizes of a plurality of types of, e.g., B4, A3, A4, B5, etc. In this embodiment, with respect to this recording material used in a calibration process, in order to avoid an error in which portrait orientation and landscape orientation are erroneously recognized in a later reading operation, setting is made so that a so-called large-sized paper, i.e., sheets of A3 and 11″×17″ sizes is used.

The color toner patch may be any of ones of Y, M, C and Bk, but in this embodiment, the toner of C (cyan) was used. In the color toner patch image Y shown in FIG. 11, a stripe-like pattern (stripe pattern) at a halftone density is included.

When output of the color toner test patch Y is ended, the CPU 204 reads the density of the test patch Y by the color sensor 14 and converts the density from a signal sent via the color sensor portion 215 (read RGB value) into an optical density (S602). In order to convert from brightness into the density, the above-described mathematic expression (1) is used. The correction coefficient kc is adjusted in order to make the density equal to the value of the commercially available densitometer.

Next, a method in which the cyan density is corrected from the obtained density information will be described. The cyan density is determined for detecting the transparent toner density, and may be roughly any value if the density is determined in a range of 1.0-1.6, but in this embodiment, the density is corrected to 1.2.

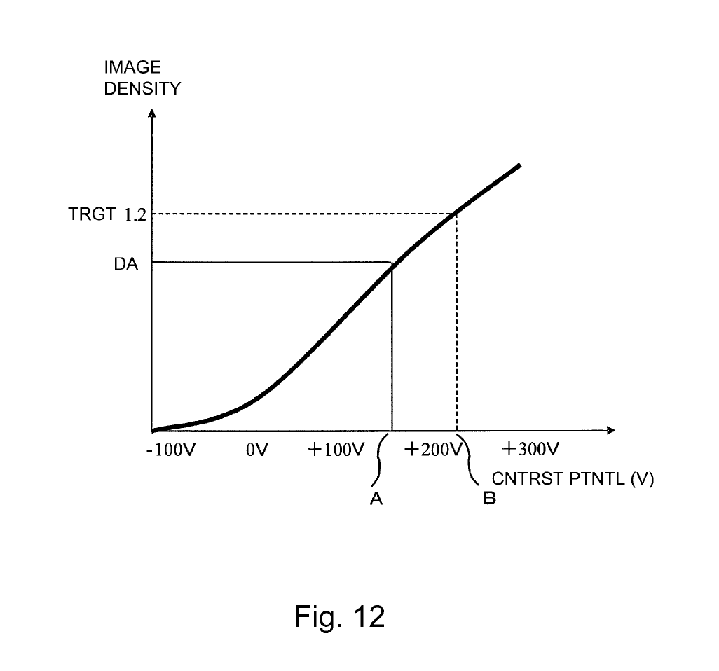

FIG. 12 is a graph showing a relationship between a relative drum surface potential of the photosensitive drum 1c and an image density obtained by computing of the mathematical expression (1). In the figure, a value A is a contrast potential when the test patch Y is printed, i.e., a difference between a developing bias potential and a surface potential of the photosensitive drum 1c photo-sensed, after being primary-charged, by the modulated laser light. A correlation between the modulated laser light and the surface potential on the photosensitive drum 1c is obtained as data in advance at a stage in which the electric power of the image forming apparatus is turned on. Further, a value DA shows the image density obtained from the printed patch at the gradation level 255 of the gradation levels of 0-255.

A contrast potential B corresponding to a target density (target control density) is obtained from the following mathematical expression (2).

B=A×1.2/DA (2)

Then, in order to correct the contrast potential A to the contrast potential B, the CPU 204 stores, in the RAM 201, a correction coefficient Vcont.rate 1 shown by the following mathematical expression (3).

Vcont.rate 1=B/A (3)

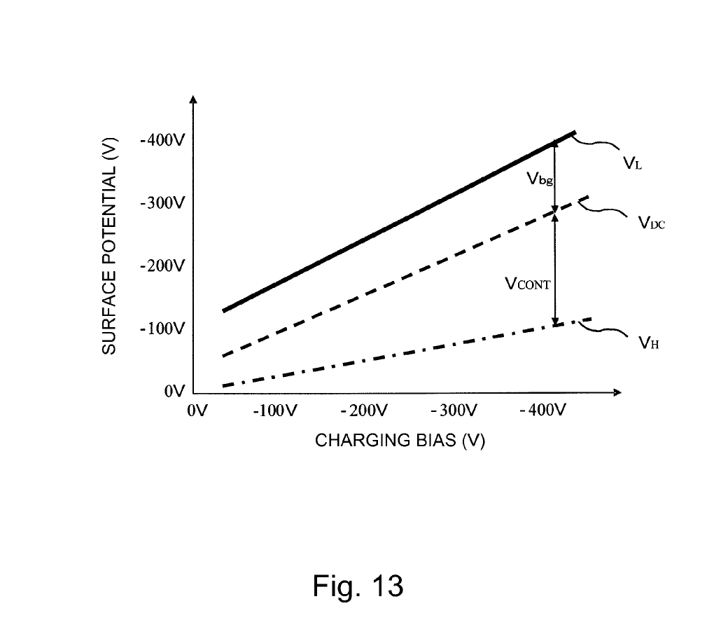

Next, a method in which the charging bias and the developing bias are obtained from the contrast potential will be briefly described. FIG. 13 is a graph showing a relationship between the charging bias (grid bias) and the surface potential of the photosensitive drum 1c. First, at the charging bias of −200 V, a surface potential VL of the photosensitive drum 1c photosensed by the laser light modulated at a minimum signal value and a surface potential VH of the photosensitive drum 1c photosensed by the laser light modulated at a maximum signal value are measured by a surface potential sensor (not shown). Similarly, the surface potentials VL and VH of the photosensitive drum 1 when the charging bias is −400 V are measured. Further, data of the charging bias of −200 V and data of the charging bias of −400 V are interpolated and extrapolated to obtain a relationship between the charging bias and the surface potential. Incidentally, control for obtaining this data is referred to as potential measurement control.

Next, from the surface potential VL, a difference of Vbg (e.g., 100 V) set so that toner fog is not generated on the image is provided, so that a developing bias VDC is set. The contrast potential Vcont is a differential voltage between the developing bias VDC and the potential VH on the photosensitive drum photo-sensed by the pulse signal (PWM value) corresponding to the maximum density. The increase in maximum density with the increasing contrast potential Vcont is as described above.

The charging bias and the developing bias which are used for obtaining the contrast potential B, obtained by the calculation, corresponding to the target density is obtained from the relationship shown in FIG. 13. Accordingly, the CPU 204 obtains the contrast potential so as to provide the target density of 1.2, and controls the charging bias and developing bias potentials so that the contrast potential can be obtained (S603).

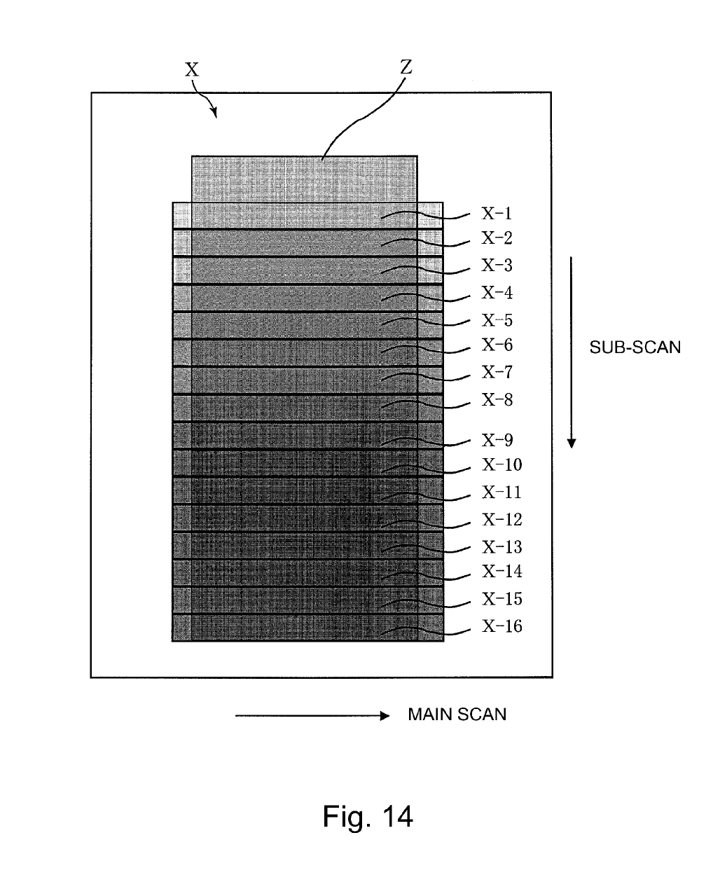

After the control for adjusting the cyan at the predetermined density (1.2 in this embodiment) is completed, the CPU 204 newly effects control so that a patch Z with the density of 1.2 is formed on the paper (S604), so that the paper is conveyed from the image forming portion 101 to the image forming portion 102. The patch Z corresponds to the color toner image with the certain toner amount shown in FIG. 8. Then, on this patch Z of the color toner, similarly as in the case where the description is made with reference to FIG. 8, a plurality of transparent toner images different in toner amount per unit area are formed to obtain the first test patch X. In this embodiment, as shown in FIG. 14, the transparent toner images different in toner amount per unit area are constituted by a group of gradation patches corresponding to 16 gradation levels. The CPU 204 forms transparent toner test patches X-1 to X-16 of 16 gradation levels on the color toner test patch Y by variably changing the laser modulation level at the transparent toner image portion 213, so that the test patch X is obtained (S605). Incidentally, as the contrast potential when the transparent toner patch is formed, an initial value registered in advance is used.

When output of the test patch X is ended, the CPU 204 reads the density of the test patch X by the color sensor 14 and converts the density into the optical density from the signal (read RGB value) sent via the color sensor portion 215, and then stores its result in the RAM 201 (S606). In order to convert from the brightness to the density, the above-described mathematical expression (1) is used.

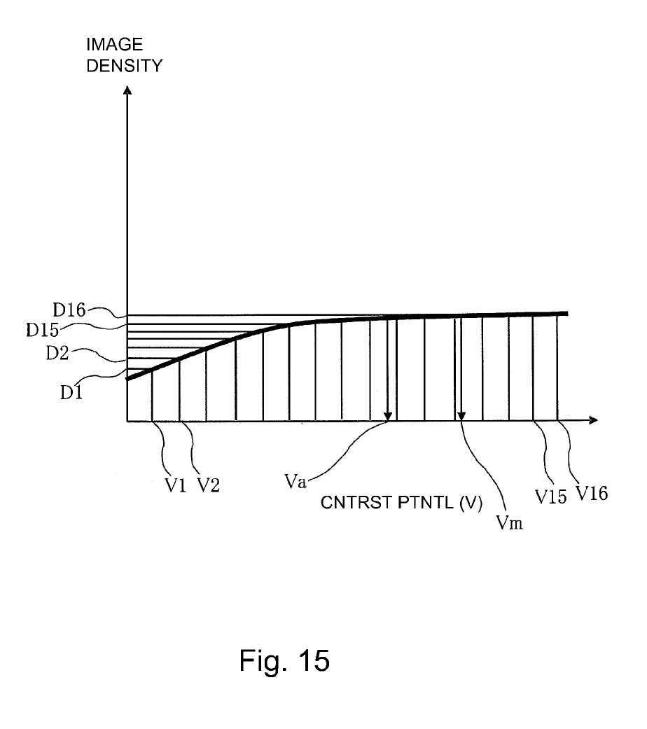

FIG. 15 is a graph showing a relationship between the relative drum surface potential (contrast potential) of the photosensitive drum 1e and the image density obtained by the computing of the mathematical expression (1). In the figure, the abscissa shows contrast potentials V1 to V16 when the test patches X-1 to X-16, i.e., a difference between the developing bias and the surface potential of the photosensitive drum 1e photo-sensed by the laser light modulated with the maximum signal value after the photosensitive drum 1e is primary-charged. Further, the ordinate shows image densities D1 to D16 corresponding to the respective contrast potentials in the case where the test patches X-1 to X-16 are formed on the test patch Z.

When the density measurement of the patch X is ended, the CPU 204 obtains the contrast potential for calculating the predetermined toner amount per unit area of the transparent toner. That is, the CPU 204 obtains a contrast potential Va corresponding to the above-described density-saturated toner amount per unit area Ta. This Va can be calculated by obtaining a slope αD of the graph of FIG. 14.

αD1=(D2−D1)/(V2−V1)

αD2=(D3−D2)/(V3−V2)

αD3=(D4−D3)/(V4−V3)

αD15=(D16−D15)/(V16−V15) (4)

Values of αD1 to αD15 obtained from this formula (4) are gradually decreased from the value of αD1, and at a certain value or more, the value substantially approaches nearer to 0. The point where the value approaches nearer to 0 is the contrast potential Va to be obtained. The CPU 204 performs a writing operation after the contrast potential Va corresponding to the density-saturated toner amount per unit area Ta.

The charging bias and the developing bias for obtaining the contrast potential Va obtained as described above are obtained from the above-described relationship shown in FIG. 13. Accordingly, the CPU 204 thus obtains the contrast potential Va and controls the charging bias and the developing bias so that the contrast potential Va can be obtained. From the above-described control, a proper image forming condition of the transparent toner is determined.

When the forming condition of the transparent toner is determined, the image formation is started. For the image forming apparatus in this embodiment, the image forming mode by the transparent toner includes the whole surface image forming mode and the partial image forming mode but in either mode, the image formation is effected under the same transparent toner (develop) forming condition. That is, the transparent toner image forming portion 102 effects formation of a normal image, which is not the test image (patch), at the charging bias and the developing bias from which the contrast potential Va corresponding to Ta which is the predetermined toner amount per unit area is obtained.

As described above, an optimum transparent toner amount per unit area can be determined by forming the transparent toner on the color toner even when complicated gradation control is not effected, so that it becomes possible to effect the image formation in which a gloss property by the transparent toner is always stable.

### [Color Toner Density Correction Control During Transparent Toner Formation]

The control of the transparent toner density by forming the transparent toner on the color toner is as described above. Next, details of color toner density correction control when the transparent toner is formed on the color toner will be described.

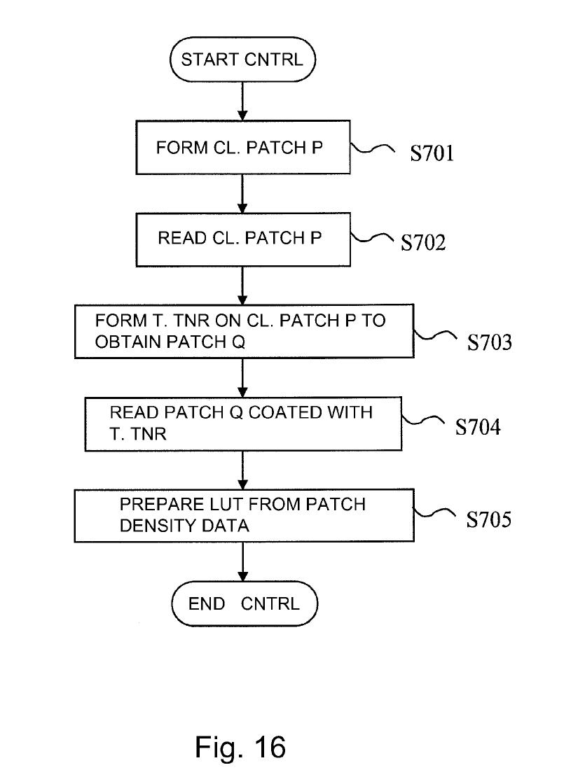

FIG. 16 is a flow chart of the color toner density correction control during the transparent toner formation.

The CPU 204 starts the color toner density correction control. This control is started by satisfying any of conditions including main switch actuation from an image forming apparatus main assembly, a lapse of a predetermined time from the main switch actuation, a predetermined number of image formation sheets, and push, by an operator of a button, of e.g., “transparent toner density correction”, provided at an operating portion 21 (FIG. 2A, FIG. 2B).

First, the CPU 204 reads out, from the ROM 201, color toner image formation information for controlling the color toner amount per unit area and various bias settings during image formation, and writes the information and the settings into the RAM 201. Thereafter, the CPU 204 controls the color toner image forming portion 101, so that a color toner test patch P is formed (S701). This test patch P corresponds to the second test image. That is, the test patch P is one obtained by forming a plurality of color toner images different in toner amount per unit area. In other words, the patch P is formed so as to include a plurality of gradation levels. As a contrast potential when such a color toner patch is formed, a predetermined value which is registered in advance is used. Further, the gradation patches formed by various changing the laser output level.

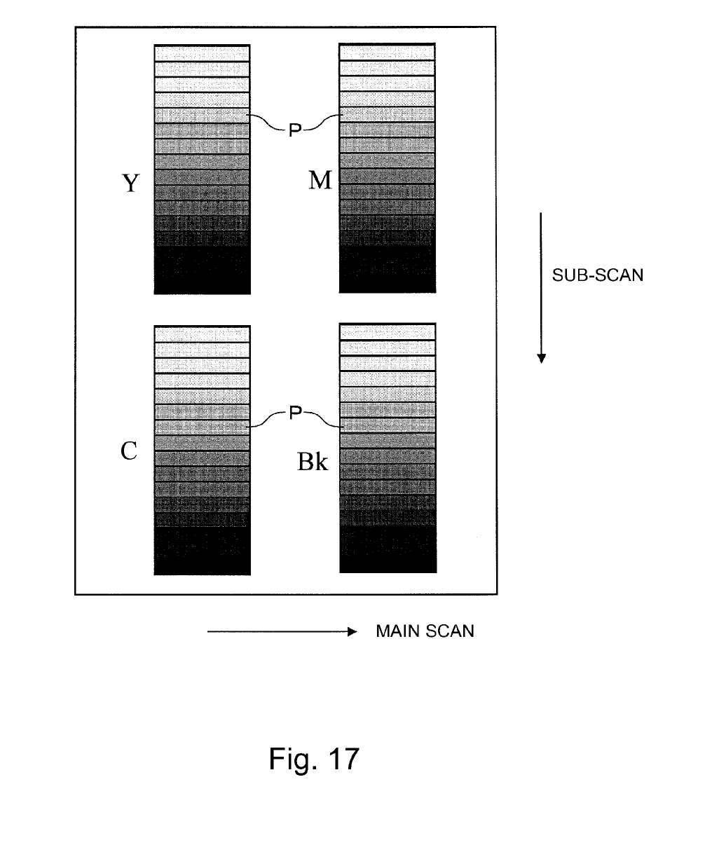

FIG. 17 shows a schematic view of the patches P of the color toners. The CPU 204 controls the color toner image portion 203 to form test patches, each at 16 gradation levels, with respect to all the colors of Y, M, C and Bk. The formed color patches P of the color toners are transferred and fixed on the recording material and are conveyed to the color sensor 14.

The CPU 204 reads the density of the test patch P by the color sensor 14 and converts the density from a signal sent via the color sensor portion 215 (read RGB value) into an optical density to store the data in the RAM 201 (S702). In order to convert from brightness into the density, the above-described mathematic expression (1) is used. The correction coefficients km, kc, ky and kk are adjusted in order to make the density equal to the value of the commercially available densitometer. The recording material provided with the test patches P is conveyed to the outside of the image forming apparatus after the test patches P are read by the color sensor 14.

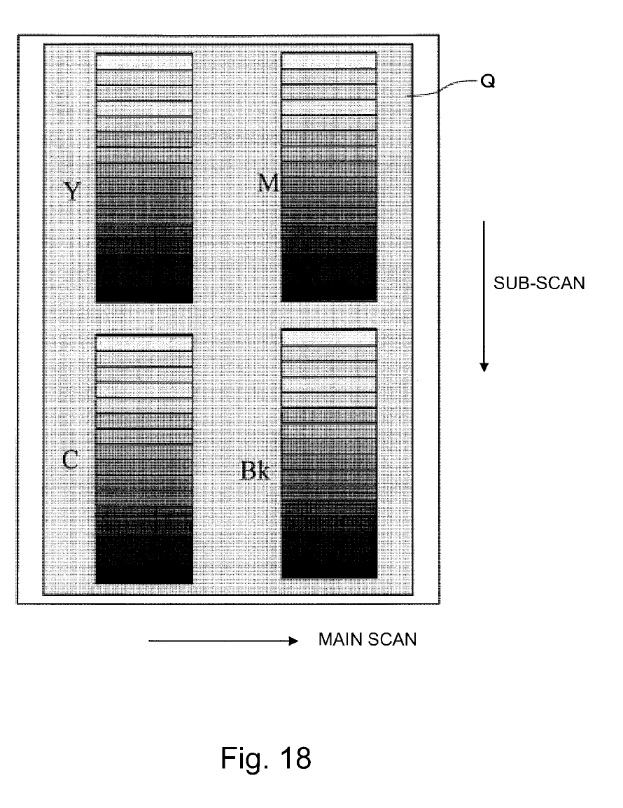

Next, as shown in FIG. 18, the gradation patches P of the toners of Y, M, C and Bk are formed on the recording material, and on the gradation patches P of these all colors, the transparent toner is formed in the above-described predetermined toner amount per unit area to obtain a test patch Q (S703). This test patch Q corresponds to the third toner image. That is, the test patch Q is formed by superposing the transparent toner image in the predetermined toner amount per unit area on the test patches P. The image formation at this time is effected by reading-out of the image forming condition, obtained by the transparent toner density control shown in FIG. 10, from the RAM 205 by the CPU 204. That is, the image formation is effected at the charging bias and the developing bias from which the contrast potential Va corresponding to Ta which is the predetermined toner amount per unit area is obtained.

Subsequently, the CPU 204 reads the density of the test patch Q by the color sensor 14 and converts the density into the optical density from the signal (read RGB value) sent via the color sensor portion 215, and then stores the data in the RAM 201 (S704). The recording material provided with the test patch Q is conveyed to the outside of the image forming apparatus after the test patch Q is read by the color sensor 14.

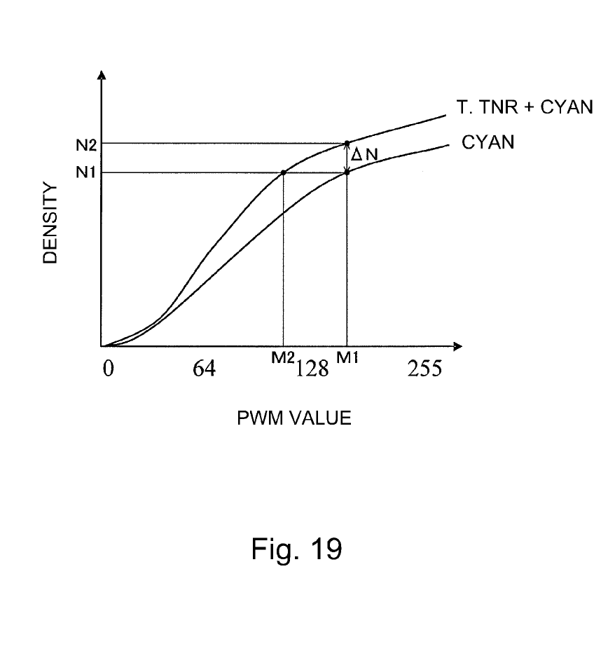

FIG. 19 shows a relationship between the PWM value (exposure time) of the color toner and a detection result (density) by the color sensor 14. In FIG. 19, only a result of the cyan toner was shown. As apparent from FIG. 19, a density gradation characteristic of cyan is such that the density becomes higher, in the case where the transparent toner is formed on the cyan toner (transparent toner+cyan), than in the case of only cyan. An increment of the density tends to increase with an increasing cyan density. Such relationship and tendency are the same also with respect to other color toners. Further, the increase in density at the portion where the transparent toner is superposed is as described above.

In this embodiment, the increase in density at the portion where the transparent toner is superposed on a part of the color toner image is thus suppressed to enable a reduction in density non-uniformity although the transparent toner is superposed. For this purpose, as is apparent from FIG. 19, there is a need to lower the PWM value in the case of (transparent toner+cyan) in order to adjust the density of (transparent toner+cyan) to the density of only cyan. Here, the PWM value and the toner amount per unit area have a proportional relation and therefore the lowering in PWM value means a decrease in toner amount per unit area.

Specifically, the CPU 204 obtains a deviation amount ΔD between the density value of the test patch Q obtained in S704 and the density value of the test patch P obtained in S702. That is, the CPU 204 obtains, from the detection result in S702, a relationship between the toner amount per unit area and density of the color toner (e.g., corresponding to the graph of cyan of FIG. 19). Next, the CPU 204 obtains, from the detection result in S704, a relationship between the toner amount per unit area and density of the color toner in the case where the transparent toner is formed (e.g., corresponding to the graph of (transparent toner+cyan) of FIG. 19). Then, from these relationships, a transparent toner correction LUT (look-up table) corresponding to the graph of FIG. 19 is prepared every color (S705). Thus, the transparent toner correction LUT is formed for each of the four colors, so that the density correction control is ended.

During the formation of the normal image, the PWM value of the color toner at the portion where the transparent toner is superposed is controlled by making reference to such a transparent toner correction LUT. That is, the color toner image forming portion 101 is controlled so that the toner amount per unit area of the color toner at the portion where the transparent toner is superposed on the part of the color toner image is smaller than the toner amount per unit area of the color image data at the superposition portion. In other words, the color toner image forming portion 101 is controlled so that the toner amount per unit area of the color toner in the case where the transparent toner is superposed is less than the toner amount per unit area of the color toner in the case where the transparent toner is not superposed. In this embodiment, the toner amount per unit area is controlled by controlling the PWM value.

This will be specifically described by FIG. 19. First, in the case where the PWM value of the cyan toner is M1, the density of only cyan is N1 (corresponding to the toner amount per unit area of the color image data), and the density of (transparent toner+cyan) is N2. In this case, ΔN (N2−N1) density becomes high in the case of (transparent toner+cyan). This shows that even when the PWM value of the cyan toner is the same M1, the density of the image formed by only the cyan toner is N1, whereas the density of the image formed in the case where the transparent toner is superposed is N2. Accordingly, in order to adjust the density in the case where the transparent toner is superposed to the density in the case where the transparent toner is not superposed, there is a need to lower the density by ΔN. Further, for this purpose, as is apparent from FIG. 19, the PWM value of the cyan toner in the case where the transparent toner is superposed is needed to be lowered to M2. In this embodiment, during the image formation, the control in which the PWM value of the color toner at the portion where the transparent toner is superposed is lowered as described above by making reference to the above-described transparent toner correction LUT at any time is effected.

Thus, by using the transparent toner correction LUT in the transparent toner image forming mode, it is possible to reduce (in addition, to eliminate) the density rise generated when the transparent toner is formed on the color toner. Further, it is possible to uniformize the density irrespective of the presence or absence of the transparent toner which becomes conspicuous in, e.g., the partial clear mode.

### [Control in More Consideration of Glossiness]

In the above-described explanation, the control is effected by using, as the predetermined toner amount per unit area, the toner amount per unit area Ta of the transparent toner in which the density is saturated, but the control can also be effected by using, as the predetermined toner amount per unit area, the toner amount per unit area Tm of the transparent toner in which the glossiness is saturated. This point will be described. First, as shown in FIG. 7, Tm is one obtained by adding Tb to Ta. Further, the contrast potential corresponding to Tm is Vm in FIG. 15. In this embodiment, this Vm is determined by a detection result by the environment sensor 15. That is, the image forming apparatus in this embodiment detects a temperature and humidity in the apparatus by the environment sensor 15. A detection signal of the environment sensor 15 is, as shown in FIG. 9, sent to the CPU 204 via the environment sensor portion 216. Then, the CPU 204 obtains Vm on the basis of the detection result of the environment sensor 15. In this embodiment, a table of a relationship between absolute motor content and Vm in Table 1 described later is provided.

The reason why the toner amount per unit area Tm (contrast potential Vm) of the transparent toner in which the glossiness is saturated is defined by the relationship with the absolute water content will be described. First, the glossiness ordinarily increases depending on the transparent toner amount (toner amount per unit area) unless the color toner amount is excessive. The toner amount per unit area changes depending on the toner charge amount if the image forming condition such as the contrast potential is the same. That is, there is a tendency that the toner amount per unit area becomes high if the toner charge amount is low, and becomes low if the toner charge amount is high. Here, the toner charge amount is liable to change depending on an operation environment, particularly on the absolute water content. That is, the toner charge amount becomes low if the absolute water content is high, and becomes high if the absolute water content is low.

From the above, it is understood that the absolute water content relates to the toner charge amount and by extension to the toner amount per unit area. For this reason, in this embodiment, the operation environment is obtained by the environment sensor 15, and depending on this environment, the toner amount per unit area, i.e., the contrast potential Vm in this embodiment is obtained. This relationship is shown in the following Table 1.

TABLE 1

EMV*¹

| | 1 | 2 | 3 | 4 |
|---|---|---|---|---|
| AWC*² | 0.2-1.0 | 1.0-3.0 | 3.0-6.0 | 6.0-10 |
| Vm | Va + 90 | Va + 85 | Va + 80 | Va + 75 |

| | EMV*¹ | | |
|---|---|---|---|
| | 5 | 6 | 7 |
| AWC*² | 10-15 | 15-25 | ≧25 |
| Vm | Va + 70 | Va + 65 | Va + 60 |

*¹“EMV” is the environment.
*²“AWC” is the absolute water content (g/m³).

In this embodiment, the environment is divided into 7 blocks depending on the absolute water content. Further, in each environment, a correction amount for the contrast potential Va is determined as Vm. The numerical value added to Va in Table 1 corresponds to Tb. That is, this Table 1 is a relationship of the correction amount of the toner amount per unit area Tm of the transparent toner in which the glossiness of the transparent toner image with respect to the environment is saturated. Then, the glossiness saturated toner amount per unit area Tm (corresponding to Vm) is calculated by adding the correction amount (value corresponding to Tb), corresponding to the detection result of the environment sensor, to the density-saturated toner amount per unit area Ta (corresponding to Va). When Tm is thus obtained, the above-described predetermined toner amount per unit area of the transparent toner is changed to the glossiness-saturated toner amount per unit area Tm in place of the density-saturated toner amount per unit area Ta, and the control of the normal image is effected by using this Tm.

The charging bias and the developing bias which are used for obtaining the contrast potential Vm obtained by the calculation is obtained from the relationship shown in FIG. 13. Accordingly, the CPU 204 thus obtains the contrast potential Vm and determines the charging bias and developing bias potentials so that the contrast potential Vm can be obtained.

Thus, by effecting the control in view of the glossiness, the glossiness at the portion where the transparent toner is superposed can be made uniform, so that an image quality can be further improved.

### Second Embodiment

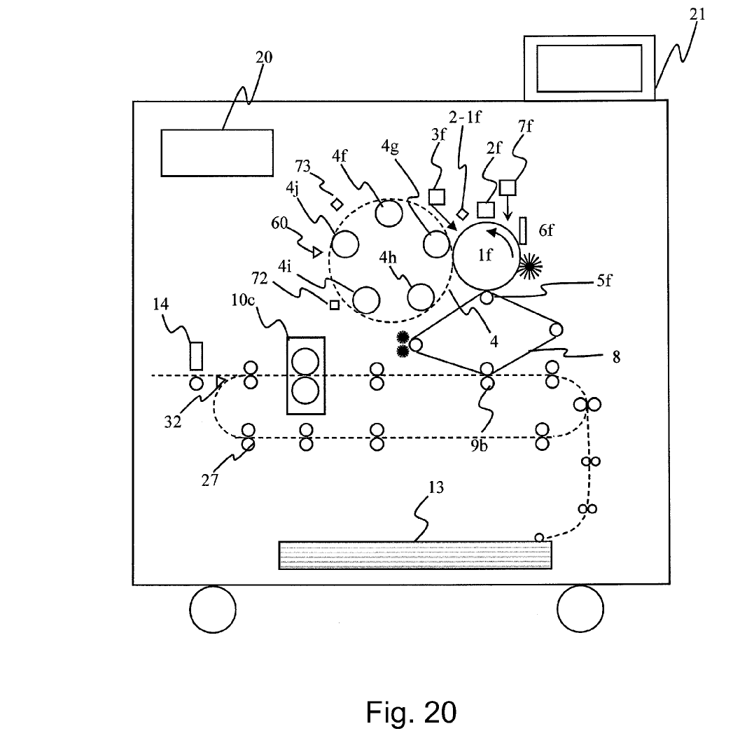

Second Embodiment of the present invention will be described by using FIG. 20. In the above-described First Embodiment, as shown in FIG. 1 showing the schematic structure of the image forming apparatus, the image forming apparatus in which the color toner image forming portion 101 and the transparent toner image forming portion 102 are connected was described. However, the image forming apparatus constitution for effecting the control by the present invention is not limited to the constitution in which the color toner image forming portion and the transparent toner image forming portion are connected. For example, as in this embodiment, the present invention is applicable to also an image forming apparatus in which color toner image formation and transparent toner image formation are effected on the same image bearing member by using a plurality of rotatable developing devices. In the following, the constitution of this embodiment will be described.

In the image forming apparatus in this embodiment, a photosensitive drum 1f as the image bearing member is provided at an image forming portion, and the photosensitive drum 1f is rotationally driven in an arrow A direction at a speed of, e.g., 300 mm/s. At a periphery of the photosensitive drum 1f, a corona charger (primary charger) 2f, an exposure device 3f, a potential measuring device 2-1f, a rotary developing device (apparatus) 4 and a cleaner device 6f are disposed. Further, at a position adjacent to the photosensitive drum 1f, an intermediary transfer belt 8 is disposed, and at an opposing position to the photosensitive drum 1f via the intermediary transfer belt 8, a primary transfer roller 5f is disposed.

In the rotary developing device 4, developing devices 4f, 4g, 4h, 4i and 4j corresponding to 5 colors for development with the color toners and the transparent toner are incorporated, and are rotationally driven. A lock-detecting sensor 72 such as a photo-interrupter for detecting an operation of the mechanism is disposed. Further, a position detecting flag 73 is mounted, and the position of the position detecting flag 73 is detected by an HP (home position) sensor 60.

The developing devices 4f, 4g, 4h, 4i and 4j develop a latent image on the photosensitive drum 1f with the color toners of Y, M, C and Bk and the transparent toner, respectively. When the latent image is developed with the toner of each color, the rotary developing device 4 is rotated in an arrow R direction. Then, the position detecting flag 73 mounted to the rotary developing device 4 is detected by the HP sensor 60, so that a reference position of the rotary developing device 4 is detected. Thereafter, the rotary developing device 4 is rotated to a predetermined position, so that positional alignment is made so that the developing device for an associated color contacts the photosensitive drum 1f.

The color toner images of the four colors used for development on the photosensitive drum 1f are successively transferred onto the intermediary transfer belt 8 by the primary transfer roller 5f, so that the toner images of the respective colors are superposed on the intermediary transfer belt 8. The toner images formed on the intermediary transfer belt 8 are secondary-transferred onto the recording material by a secondary transfer roller 9b, and the recording material on which the toner images are secondary-transferred is conveyed to a fixing device 10c, where the unfixed toner images are heat-fixed.

Next, in order to form the transparent toner on the color toner, a flapper 32 is operated to convey the sheet toward a conveying roller 27 side, and the sheet is conveyed by the conveying roller 27. Thereafter, the recording material (sheet) is conveyed to a conveying path extending from a sheet feeding cassette 13, and is again conveyed toward the secondary transfer roller 9b.

Next, the transparent toner image formation is effected on the color toners which are transferred and fixed. The rotary developing device 4 rotates the developing device 4j for the development with the transparent toner. Similarly as in the development with the color toners, the position detecting flag 73 mounted to the rotary developing device 4 is detected by the HP sensor 60, so that a reference position of the rotary developing device 4 is detected. Thereafter, the developing device 4j is rotated to a predetermined position, so that positional alignment is made so that the developing device 4j for an associated color contacts the photosensitive drum 1f.

The transparent toner image used for development on the photosensitive drum 1f is transferred onto the intermediary transfer belt 8 by the primary transfer roller 5f, and is further secondary-transferred onto the recording material by a secondary transfer roller 9b. Then, the recording material on which the transparent toner image is secondary-transferred is conveyed to a fixing device 10c, where the unfixed toner images are heat-fixed. Incidentally, in the case of this embodiment, all the constitutions including the developing devices 4f to 4i and excluding the developing device 4j are a color image forming means, and all the constitutions including the developing device 4j and excluding the developing devices 4f to 4i are a transparent image forming means. Other constitutions and actions are similar to those in the above-described First Embodiment.

### Other Embodiment

In the above-described explanation, the CPU 204 controlled the PWM value for controlling the toner amount per unit area of the color toner. However, a control value is not limited to this value but other values can be used. For example, the toner amount per unit area is controlled by controlling at least one of the exposure amount by the exposure means, the exposure time by the exposure means, the developing bias and the transfer bias. Further, a decrease amount of the toner amount per unit area of the color toner at the portion where the transparent toner is superposed is obtained in advance, and then the control may also be effected uniformly. Further, the predetermined toner amount per unit area of the transparent toner is not limited to the Ta or Tm as described above but may also be determined as an appropriate amount. For example, the predetermined toner amount per unit area may also be a certain toner amount per unit area which is less than, e.g., the density-saturated toner amount per unit area.

### INDUSTRIAL APPLICABILITY

As described above, according to the present invention, even in the case where the image by the color toner is partly covered with the transparent toner, the density non-uniformity can be suppressed.

1. An image forming apparatus comprising:
color image forming means for effecting image formation with a color toner on the basis of color image data;
transparent image forming means for effecting image formation, on the basis of transparent image data, with a transparent toner on a color toner image formed by said color toner forming means;
fixing means for fixing a formed image, on a recording material, of the transparent toner superposed on the color toner; and
control means for controlling said color image forming means, so that a toner amount per unit area of the color toner at a superposing portion of the transparent toner on the color toner image is less than that of the color image data at the superposing portion.

2. An image forming apparatus according to claim 1, wherein said color image forming means includes an image bearing member for bearing a toner image, charging means for electrically charging a surface of the image bearing member by applying a charging bias, exposure means for exposing to light a charged portion of the image bearing member by the charging means to form an electrostatic latent image, developing means for developing the electrostatic latent image into the toner image with a toner by applying a developing bias, and transfer means for transferring the toner image from the image bearing member onto another image bearing member or the recording material or from the another image bearing member onto the recording material by applying a transfer bias, and wherein said control means controls at least one of the charging bias, a quantity of light by the exposure means, an exposure time by the exposure means, the developing bias, and the transfer bias.

3. An image forming apparatus according to claim 1, comprising a density detecting means for detecting a density of the image fixed on the recording material, wherein said color image forming means and said transparent image forming means form a first test image in which a portion transparent toner images different in toner amount per unit area are formed on the color toner image with a certain toner amount per unit area, wherein said density detecting means detects the density of the first test image fixed on the recording material by the fixing means, wherein said control means calculates a density saturation toner amount per unit area, which is the toner amount per unit area of the transparent toner for which an increase in density with respect to an increase in toner amount per unit area of the transparent toner is saturated, from the density of the image test image detected by said density detecting means, wherein said transparent image forming means effects formation of an ordinary image, which is not the test image, in a predetermined toner amount per unit area, and wherein the predetermined toner amount per unit area is the density saturation toner amount per unit area.

4. An image forming apparatus according to claim 3, comprising an environment sensor for detecting a temperature and a humidity in said image forming apparatus, wherein said control means has a relationship of a correction amount for the toner amount per unit area of the transparent toner in which glossiness of the image of the transparent toner with respect to environment is saturated, and calculates a glossiness saturation toner amount per unit area by adding the correction amount corresponding to a detection result of said environment sensor to the density saturation toner amount per unit area, and wherein as the predetermined toner amount per unit area, the glossiness saturation toner amount per unit area is used in place of the density saturation toner amount per unit area.

5. An image forming apparatus according to claim 3, wherein said color image forming means forms a second test image in which a portion color toner images different in toner amount per unit area are formed,
wherein said transparent image forming means forms a third test image formed by superposing a transparent toner image in the predetermined toner amount per unit area on the second test image,
wherein said density detecting means detects densities of the second test image and the third test image which are fixed on the recording material by the fixing means, and
wherein said control means obtains each of a relationship between the toner amount per unit area and density of the color toner from the density of the second toner image detected by said density detecting means and a relationship between the toner amount per unit area and density of the transparent toner, in the case where the image of the transparent toner is superposedly formed, from the density of the third test image detected by said density detecting means, and from these relationships, controls said color image forming means so that the toner amount per unit area of the color toner in the case where the transparent toner is superposed on a part of the image of the color toner is less than the toner amount per unit area of the color toner in the case where the transparent toner is not superposed on the part.
